(19) United States
(12) Patent Application Publication
(10) Pub. No.: US 2015/0240533 A1
(43) Pub. Date: Aug. 27, 2015

(54) LATCH HOUSING WITH INTEGRAL ATTACHMENT FEATURES

(71) Applicants: Robert Milne, Sterling Heights, MI (US); John Rice, New Baltimore, MI (US); Donald M. Perkins, Sterling Heights, MI (US); Ian Dow, Bloomfield, MI (US)

(72) Inventors: Robert Milne, Sterling Heights, MI (US); John Rice, New Baltimore, MI (US); Donald M. Perkins, Sterling Heights, MI (US); Ian Dow, Bloomfield, MI (US)

(21) Appl. No.: 14/624,181

(22) Filed: Feb. 17, 2015

Related U.S. Application Data
(60) Provisional application No. 61/942,945, filed on Feb. 21, 2014.

(51) Int. Cl. E05B 81/00; E05C 3/12

(52) U.S. Cl. CPC E05B 81/00; E05C 3/12

(57) ABSTRACT

A latch, having: an actuator housing configured to be coupled to a latch housing of the latch by only a single screw. A lock/unlock actuator of a vehicle latch having an actuator housing that is secured to a latch housing via a single screw and at least two pairs of integral features formed in the actuator housing and the latch housing.

### CROSS REFERENCE TO RELATED APPLICATIONS

This application claims the benefit of U.S. Provisional Patent Application Ser. No. 61/942,945 filed on Feb. 21, 2014, the entire contents of which are incorporated herein by reference thereto.

### BACKGROUND

Various embodiments of the present invention relate to a latch and more particularly, a vehicle latch.

In some applications, latches are required to perform numerous operations within limited confines of an application area of the item they are installed in.

Accordingly, it is desirable to provide a latch with a latch housing that is able to perform the required functions while being subject to certain space requirements.

### SUMMARY OF THE INVENTION

A latch, having: an actuator housing configured to be coupled to a latch housing of the latch by only a single screw.

In another embodiment, a combination of a latch housing and an actuator housing is provided. The combination being configured to be secured to each other by a single fastener.

In another embodiment, a lock/unlock actuator of a vehicle latch is provided. The actuator having an actuator housing that is secured to a latch housing via a single screw and at least two pairs of integral features formed in the actuator housing and the latch housing.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIGS. 1-4 are views of a latch and associated housings according to various embodiments of the present invention; and

FIG. 5 is partial cross-sectional view of the actuator housing and the latch illustrating integral securement features.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Reference is made to the following U.S. Pat. Nos. 3,969,789; 6,568,741; 6,679,531; 8,348,310 and U.S. Patent Publication Nos. US 2010/0127512; US 2011/0204659; US 2012/0292927 and provisional Patent Application Ser. No. 61/806,530 filed Mar. 29, 2013, the entire contents each of which are incorporated herein by reference thereto.

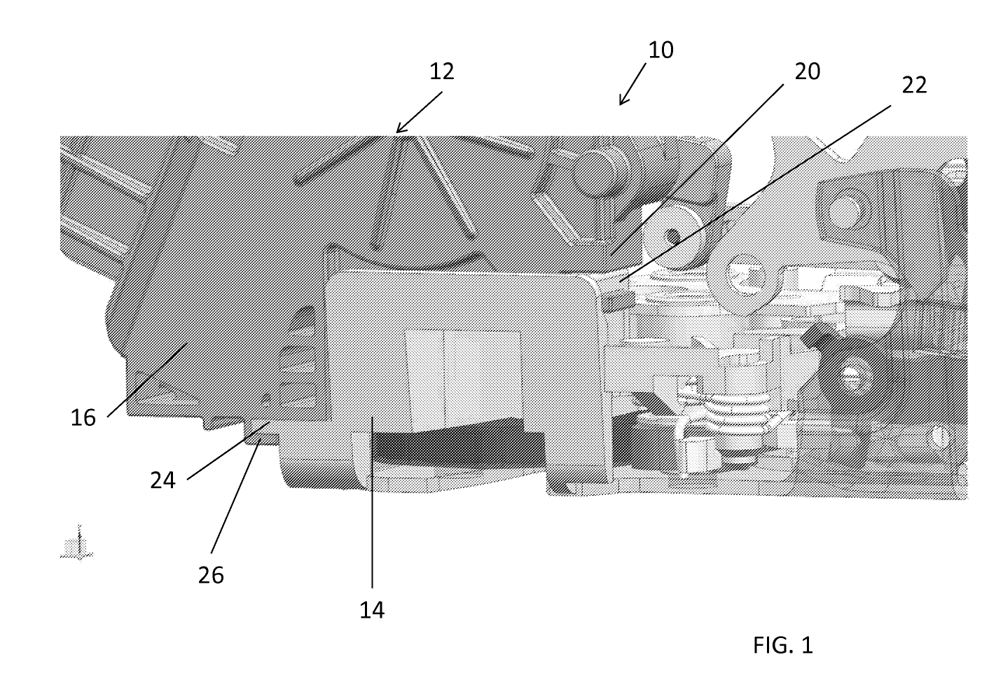

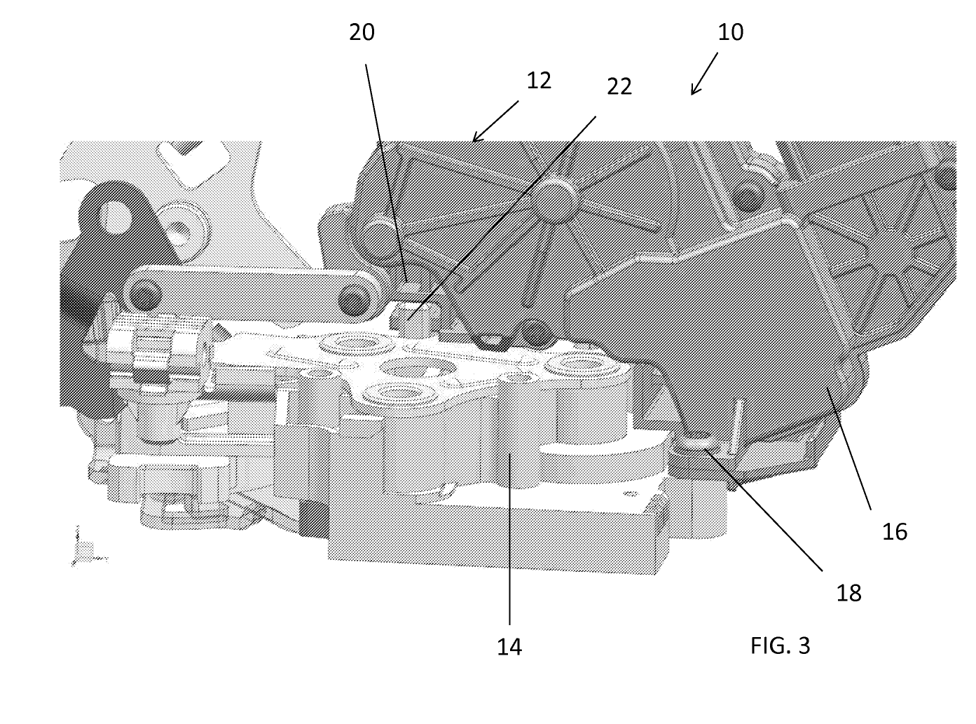

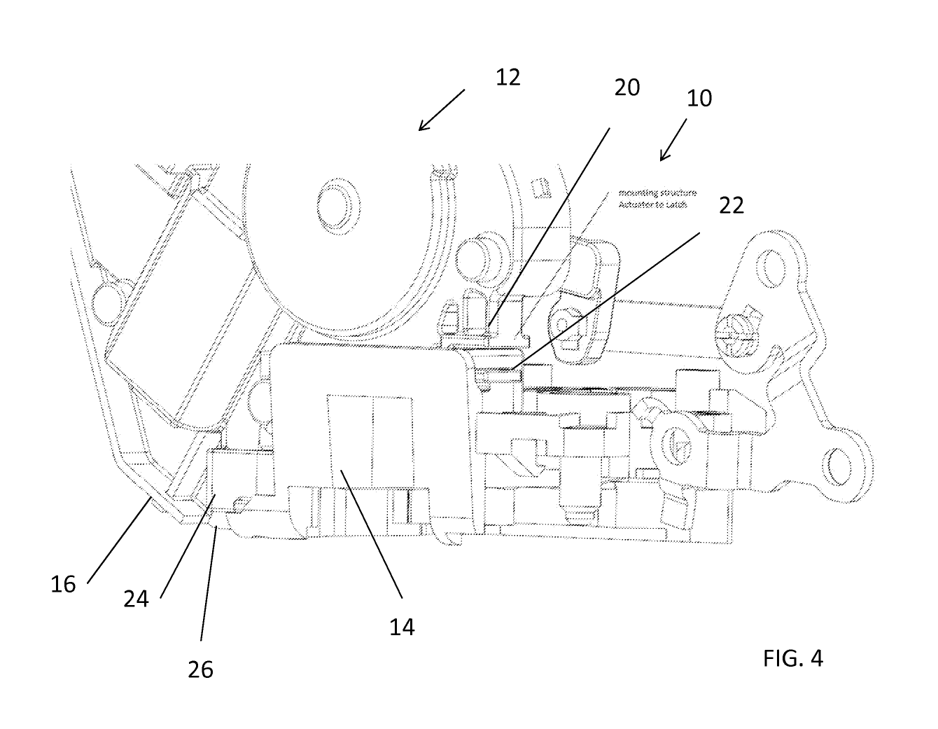

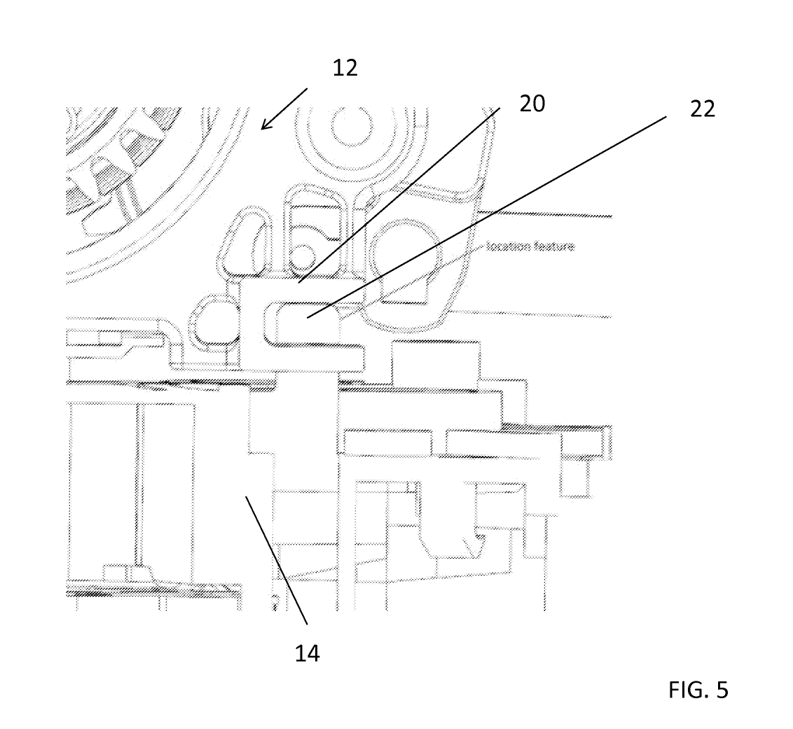

Referring now to the FIGS. and in particular, FIGS. 1-4, a latch 10 is illustrated. In one embodiment, the latch 10 is a vehicle door latch or any other type of vehicle latch. Latch 10 has an actuator 12 operatively coupled to components of the latch 10 that are located within or secured to a latch housing 14. The actuator 12 has an actuator housing 16 that is configured to be coupled to the latch housing 14 with a minimal amount of components.

The mounting arrangement disclosed herein reduces the number of fasteners while also still maintaining a suitable or stable attachment between the actuator 12 and the latch housing 14. In one embodiment, the arrangement allows the actuator 12 to be held into its working position with respect to the housing 14 via only a single screw or fastener 18. Accordingly, only one fastener 18 is required to secure the actuator 12 to the latch 10 or actuator housing 16 to latch housing 14.

The latch housing 14 will also have a bridge type structure to allow a mating feature on the actuator housing to control up/down and side to side movement of the actuator 12 with respect to the latch housing 14. Another feature on the latch housing 14 will engage the other end of the actuator 12 to control similar movement. These two features will stabilize the actuator in its position relative to the latch housing 12. Accordingly, a single screw fastener 18 is required to prevent the third direction movement between the latch housing and the actuator 12 or actuator housing 16.

As illustrated, the latch 10 will have an actuator 12 that utilizes a worm and worm gear solution for a lock/unlock actuator 12 of the latch 10. In order to secure the actuator housing 16 to the latch housing 14 integral securement features 20, 22, 24 and 26 are provided. The integral securement features 20, 22, 24 and 26 are molded into the housings 14 and 16, which are formed out an easily molded material such as plastic. Alternatively, the securement features may be insert molded into the housings 14 and 16.

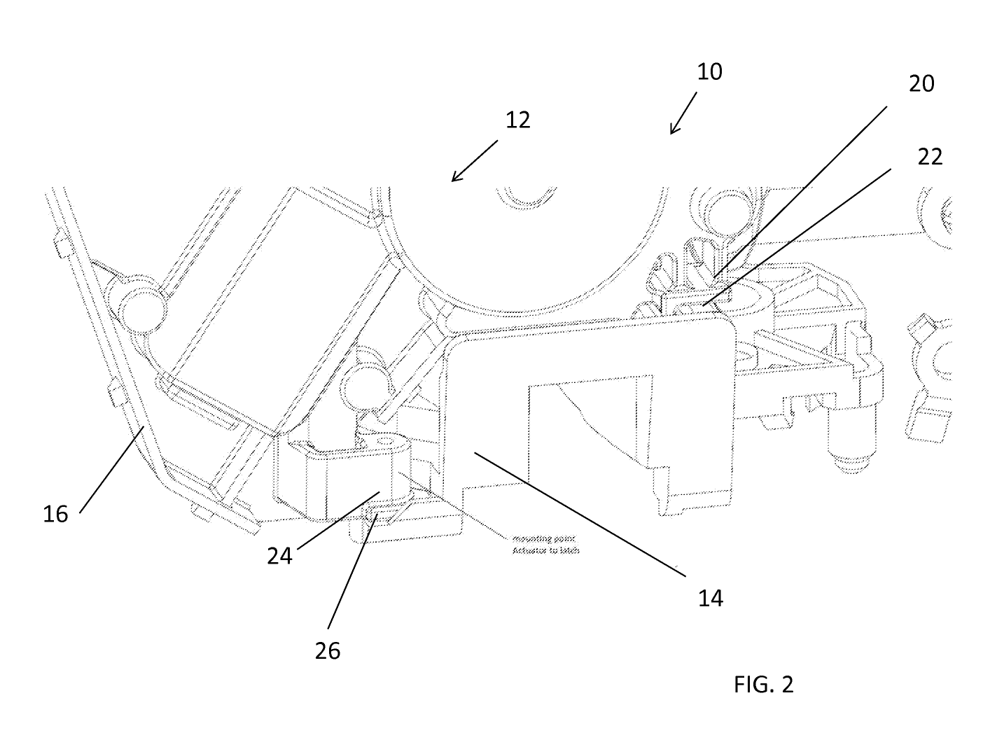

As illustrated, the integrally formed securement features 20, 22, 24 and 26 provide reaction surfaces that will maintain the actuator housing 16 in the correct position with respect to housing 14 as the actuator 12 of the latch 10 is secured thereto as well as during operation of the latch 10. It being understood that the configuration of the features 20, 22, 24 and 26 may vary for example features 24 and 26 of FIG. 1 are different from those illustrated in FIG. 2.

The illustrated features 20, 22, 24 and 26 allow the actuator housing 16 to maintain its relative position to the latch housing 14 without increasing the cost of the part. In addition and as mentioned above, features 20, 22, 24 and 26 negate the need for numerous screws or equivalent fasteners to be used and the present design configuration requires that only one screw or screw fastener 18 be used as it works in conjunction with features 20, 22, 24 and 26 of the housings 14 and 16. Thus, the need for only a single screw further reduces manufacturing costs.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch, comprising:
an actuator housing configured to be coupled to a latch housing of the latch by only a single screw.

2. The latch as in claim 1, wherein actuator housing and the latch housing each have complimentary integrally formed attachment features.

3. The latch as in claim 2, wherein the actuator housing and the latch housing are formed from plastic.

4. The latch as in claim 1, wherein the latch is a vehicle door latch.

5. The latch as in claim 2, wherein the integrally formed attachment features cooperate with each other to limit up/down and side to side movement of the actuator housing with respect to the latch housing.

6. The latch as in claim 5, wherein the integrally formed attachment features comprise two pairs of integrally formed attachment features.

7. The latch as in claim 7, wherein the up/down movement is in a first direction and the side to side movement is in a second direction and the single screw prevents movement of the actuator housing and the latch housing a third direction that is different from the first direction and the second direction.

8. In combination, a latch housing and an actuator housing each being configured to be secured to each other by a single fastener.

9. The combination as in claim 8, wherein actuator housing and the latch housing are part of a vehicle latch.

10. The combination as in claim 9, wherein actuator housing is configured to house a lock/unlock actuator of the vehicle latch.

11. The combination as in claim 8, wherein actuator housing and the latch housing each have complimentary integrally formed attachment features.

12. The combination as in claim 11, wherein the actuator housing and the latch housing are formed from plastic.

13. The combination as in claim 11, wherein the integrally formed attachment features cooperate with each other to limit up/down and side to side movement of the actuator housing with respect to the latch housing.

14. The combination as in claim 11, wherein the integrally formed attachment features comprise two pairs of integrally formed attachment features.

15. The combination as in claim 11, wherein the integrally formed attachment features cooperate with each other to limit up/down and side to side movement of the actuator housing with respect to the latch housing.

16. The combination as in claim 15, wherein the up/down movement is in a first direction and the side to side movement is in a second direction and the single fastener prevents movement of the actuator housing and the latch housing a third direction that is different from the first direction and the second direction.

17. The combination as in claim 16, wherein the single fastener is a screw.

18. The combination as in claim 11, wherein the integrally formed attachment features provide reaction surfaces that maintain the actuator housing in a specific position with respect to the latch housing.

19. A lock/unlock actuator of a vehicle latch having an actuator housing that is secured to a latch housing via a single screw and at least two pairs of integral features formed in the actuator housing and the latch housing.

20. The lock/unlock actuator as in claim 19, wherein the integral features cooperate with each other to limit up/down and side to side movement of the actuator housing with respect to the latch housing and wherein the up/down movement is in a first direction and the side to side movement is in a second direction and the single screw prevents movement of the actuator housing and the latch housing a third direction that is different from the first direction and the second direction.
